(19) United States
(12) Patent Application Publication
(10) Pub. No.: US 2005/0111754 A1
(43) Pub. Date: May 26, 2005

(54) Methods, systems and computer program products for fusion of high spatial resolution imagery with lower spatial resolution imagery using a multiresolution approach

(76) Inventors: Halil I. Cakir, Raleigh, NC (US); Siamak Khorram, Raleigh, NC (US)

Correspondence Address: Elizabeth A. Stanek;Myers Bigel Sibley & Sajovec, P.A., P.O. Box 37428, Raleigh, NC, 27627, US

(21) Appl. No.: 10/982,422

(22) Filed: Nov. 4, 2004

Related U.S. Application Data
(60) Provisional application No. 60/517,430, filed on Nov. 5, 2003.

(51) Int. Cl. G06K 9/36; G06K 9/32

(52) U.S. Cl. 382/284; 382/299

(57) ABSTRACT

Methods, systems and computer program products are provided for fusing images of different spatial resolution. Data for at least two images at different spatial resolutions is obtained and relationships between the images at the different spatial resolutions are determined. A relationship between a first of the at least two images at a first spatial resolution and the first of the at least two images at a second spatial resolution, higher than the first spatial resolution is determined based on the determined relationships between the images at the different spatial resolutions. Pixel values of the first of the at least two images at the second spatial resolution are determined based on pixel values of the first of the at least two images at the first spatial resolution and the determined relationship between the first of the at least two images at the first spatial resolution and the first of the at least two images at the second spatial resolution.

### CLAIM OF PRIORITY

The present application claims the benefit of U.S. Provisional Application Ser. No. 60/517,430 (Attorney Docket No. 5051-648PR2), filed Nov. 5, 2003, the disclosure of which is hereby incorporated by reference as if set forth in its entirety.

### FIELD OF THE INVENTION

The present invention relates generally to data fusion and, more particularly, to the fusion of images having different resolutions, for example, spatial and/or spectral resolutions.

### BACKGROUND OF THE INVENTION

There are many conventional techniques used for data fusion of images with different spatial and/or spectral resolutions. Examples of some of these techniques are discussed in U.S. Pat. Nos. 6,097,835; 6,011,875; 4,683,496 and 5,949,914. Furthermore, two techniques that are widely used for data fusion of images with different resolutions are the Principal Component Analysis (PCA) method and the Multiplicative method. The PCA method may be used for, for example, image encoding, image data compression, image enhancement, digital change detection, multi-temporal dimensionality and image fusion and the like as discussed in Multisensor Image Fusion in Remote Sensing: Concepts, Methods and Applications by Pohl et al. (1998). The PCA method calculates the principal components (PCs) of a low spatial resolution image, for example, a color image, re-maps a high spatial resolution image, for example, a black and white image, into the data range of a first of the principal components (PC-1) and substitutes the high spatial resolution image for the PC-1. The PCA method may then apply an inverse principal components transform to provide the fused image. The Multiplicative method is based on a simple arithmetic integration of the two data sets as discussed below.

There are several ways to utilize the PCA method when fusing high spectral resolution multispectral data, for example, color images, with high spatial panchromatic resolution data, for example, black and white images. The most commonly used way to utilize the PCA method involves the utilization of all input bands from multispectral data. In this method, multispectral data may be transformed into principal component (PC) space using either co-variance or a correlation matrix. A first PC image of the multispectral data may be re-mapped to have approximately the same amount of variance and the same average with a corresponding high spatial resolution image. The first PC image may be replaced with the high spatial resolution image in components data. An inverse PCA transformation may be applied to the components data set including the replaced first PC image to provide the fused image.

The PCA method replaces the first PC image with the high spatial resolution data because the first PC image (PC 1) has the information common to all bands in multispectral data, which is typically associated with spatial details. However, since the first PC image accounts for most of the variances in multispectral data, replacing the first PC image with the high spatial resolution data may significantly affect the final fused image. In other words, the spectral characteristic of the final fused image may be altered. Accordingly, there may be an increased correlation between the fused image bands and high spatial resolution data.

Using the Multiplicative method, a multispectral image (color image) may be multiplied by a higher spatial resolution panchromatic image (black and white image) to increase the spatial resolution of the multispectral image. After multiplication, pixel values may be rescaled back to the original data range. For example, with 8-bit data, pixel values range between 0 and 255. This is the radiometric resolution of 8-bit data. After multiplication, these values may exceed the radiometric resolution range of input data. To keep the output (fused) image within the data range of input data, data values may be rescaled back to so to fall within the 0-255 range to have the same radiometric resolution with the input data.

The Multiplicative method may increase the intensity component, which may be good for highlighting urban features. The resulting fused image of the Multiplicative method may have increased correlation to panchromatic image. Thus, spectral variability may be decreased in the output (fused) image compared to the original (input) multispectral image. In other words, the fused image resulting from the multispectral method may also have altered spectral characteristics. Thus, improved methods of fusing images having different spatial and/or spectral resolutions may be desired.

### SUMMARY OF THE INVENTION

Embodiments of the present invention provide for methods, systems and computer program products for fusing images of different spatial resolution. Data for at least two images at different spatial resolutions is obtained and relationships between the images at the different spatial resolutions are determined. A relationship between a first of the at least two images at a first spatial resolution and the first of the at least two images at a second spatial resolution, higher than the first spatial resolution is determined based on the determined relationships between the images at the different spatial resolutions. Pixel values of the first of the at least two images at the second spatial resolution are determined based on pixel values of the first of the at least two images at the first spatial resolution and the determined relationship between the first of the at least two images at the first spatial resolution and the first of the at least two images at the second spatial resolution.

In further embodiments of the present invention, the data may be obtained for a multispectral image and a panchromatic image. In certain embodiments of the present invention, the data may be obtained for an image having a high spatial resolution and a low spectral resolution and for an image having a low spatial resolution and a high spectral resolution. The multispectral image may be resampled to obtain lower resolution images associated with the multispectral image and the panchromatic image may be resampled to obtain lower resolution images associated with the panchromatic image.

In still further embodiments of the present invention, the determined relationships between the at least two images at different spatial resolutions may be linear relationships. The pixel values may be determined using a first principal component of the first of the at least two images at the first spatial resolution. The relationships may be determined between the at least two images having different areas and the areas may be associated with corresponding digital value numbers. The digital value numbers may include a fifteen meter digital value number, a thirty meter digital value number, a sixty meter digital value number and/or a one hundred and twenty meter digital value number.

### BRIEF DESCRIPTION OF THE FIGURES

FIG. 1 is a block diagram of data processing systems suitable for use in embodiments of the present invention.

FIG. 2 is a more detailed block diagram of aspects of data processing systems that may be used in embodiments of the present invention.

FIG. 3 is a flow chart illustrating operations according to some embodiments of the present invention.

FIG. 4 is a block diagram illustrating operations according to some embodiments of the present invention.

FIG. 5 illustrates a comparison of images fused with different techniques.

FIG. 6 illustrates histograms of the original image, images generated according to methods according to some embodiments of the present invention and PCA method images.

FIG. 7 is a graph illustrating inter-band correlations for the original and fused images.

FIG. 8 is a graph illustrating correlations between panchromatic and other bands for original and fused images.

### DETAILED DESCRIPTION OF THE INVENTION

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, the invention may be embodied as a method, data processing system, or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language or in a visually oriented programming environment, such as VisualBasic.

The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The invention is described in part below with reference to flowchart illustrations and/or block diagrams of methods, systems and computer program products according to embodiments of the invention. It will be understood that each block of the illustrations, and combinations of blocks, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

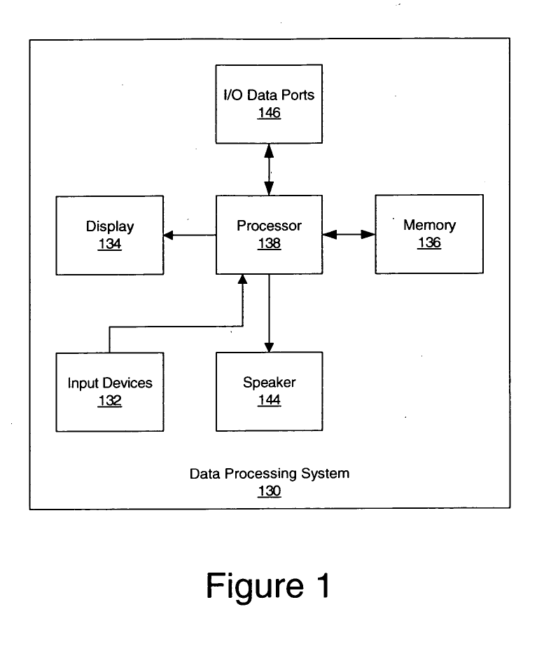

Embodiments of the present invention will now be described with respect to FIGS. 1 through 8. Some embodiments of the present invention provide methods, systems and computer program products for fusing images having different spatial resolutions. Data for at least two images having different spatial resolutions, for example, different spatial and/or spectral resolutions, is obtained. Relationships may be determined between the at least two images at different spatial resolutions. For example, a panchromatic image may be resampled to provide three images associated with the panchromatic image each of the images having a lower resolution than the original panchromatic images. These panchromatic images may be compared with multispectral images having corresponding resolutions to determine the relationships between the panchromatic and the multispectral images at the different resolutions.

A relationship may be established between a first of the at least two images at a first spatial resolution and the first of the at least two images at a second spatial resolution, higher than the first spatial resolution, based on the determined relationships between the at least two images at the different spatial resolutions. Pixel values of the first of the at least two images at the second spatial resolution may be determined based on pixel values of the first of the at least two images at the first spatial resolution and the determined relationship between the first of the at least two images at the first spatial resolution and the first of the at least two images at the second spatial resolution, which may provide a resulting fused image having a color close to the original as discussed further herein below.

Referring now to FIG. 1, an exemplary embodiment of data processing systems 130 suitable for data fusion in accordance with embodiments of the present invention will be discussed. The data processing system 130 typically includes input device(s) 132 such as a keyboard, pointer, mouse and/or keypad, a display 134, and a memory 136 that communicate with a processor 138. The data processing system 130 may further include a speaker 144, and an I/O data port(s) 146 that also communicate with the processor 138. The I/O data ports 146 can be used to transfer information between the data processing system 130 and another computer system or a network. These components may be conventional components, such as those used in many conventional data processing systems, which may be configured to operate as described herein.

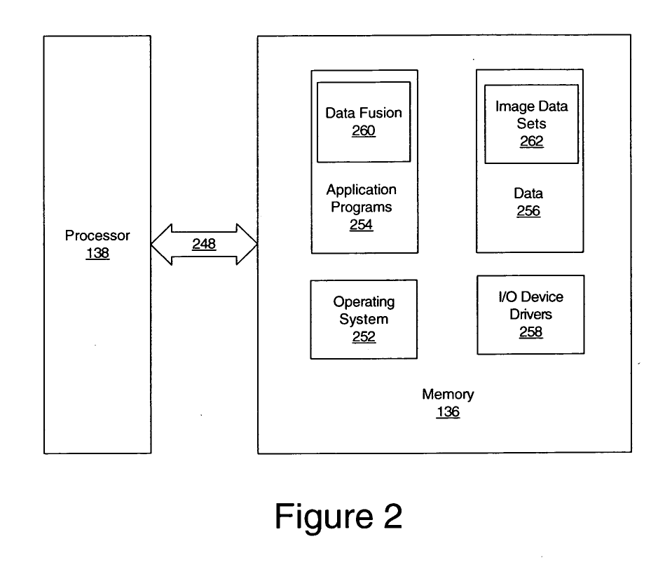

Referring now to FIG. 2, a block diagram of data processing systems that illustrate systems, methods, and computer program products in accordance with some embodiments of the present invention. The processor 138 communicates with the memory 136 via an address/data bus 248. The processor 138 can be any commercially available or custom microprocessor. The memory 136 is representative of the overall hierarchy of memory devices, and may contain the software and data used to implement the functionality of the data processing system 130. The memory 136 can include, but is not limited to, the following types of devices: cache, ROM, PROM, EPROM, EEPROM, flash memory, SRAM, and DRAM.

As shown in FIG. 2, the memory 136 may include several categories of software and data used in the data processing system 130: the operating system 252; the application programs 254; the input/output (I/O) device drivers 258; and the data 256, which may include hierarchical data sets. As will be appreciated by those of skill in the art, the operating system 252 may be any operating system suitable for use with a data processing system, such as OS/2, AIX or System390 from International Business Machines Corporation, Armonk, N.Y., Windows95, Windows98, Windows2000 or WindowsXP from Microsoft Corporation, Redmond, Wash., Unix or Linux. The I/O device drivers 258 typically include software routines accessed through the operating system 252 by the application programs 254 to communicate with devices such as the I/O data port(s) 146 and certain memory 136 components. The application programs 254 are illustrative of the programs that implement the various features of the data processing system 130 and preferably include at least one application that supports operations according to embodiments of the present invention. Finally, the data 256 represents the static and dynamic data used by the application programs 254, the operating system 252, the I/O device drivers 258, and other software programs that may reside in the memory 136.

As is further seen in FIG. 2, the application programs 254 may include a data fusion module 260. The data fusion module 260 may carry out the operations described herein for the fusion of different resolution data from image data sets, such as the image data sets 262. While the present invention is illustrated, for example, with reference to the data fusion module 260 being an application program in FIG. 2, as will be appreciated by those of skill in the art, other configurations may also be utilized. For example, the data fusion module 260 may also be incorporated into the operating system 252, the I/O device drivers 258 or other such logical division of the data processing system 130. Thus, the present invention should not be construed as limited to the configuration of FIG. 2 but encompasses any configuration capable of carrying out the operations described herein.

In particular, the data fusion circuit 260 is configured to obtain images of differing spatial resolutions by, for example, repeatedly resampling higher resolution images to progressively lower resolutions. Such a resampling may be carried out by any technique known to those of skill in the art. The data fusion circuit 260 may be configured to use the information gathered from successive resolutions from the images to estimate the pixel values of lower resolution imagery at the higher spatial resolution level. For example, a relationship may be established between the images at the lower resolutions so as to determine a relationship between the images at the higher resolution. The data fusion circuit 260 may be further configured to use the relationship to determine pixel values at a higher spatial resolution from the lower spatial resolution image as discussed further below.

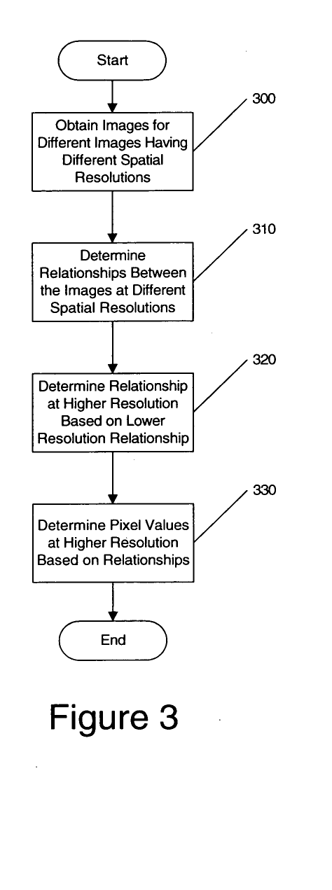

Referring now to FIG. 3, operations according to some embodiments of the present invention will be discussed. Operations begin at block 300 by obtaining images of differing spatial resolutions, for example, by repeatedly resampling higher resolution images to progressively lower resolutions. Such a resampling may be carried out by any technique known to those of skill in the art. Information gathered from successive resolutions from the images may be used to estimate the pixel values of lower resolution imagery at the higher spatial resolution level. A relationship is established between the images at the lower resolutions (block 310) so as to determine a relationship between the images at the higher resolution (block 320). The relationship is then used to determine pixel values at a higher spatial resolution from the lower spatial resolution image (block 330).

For example, for a high spatial resolution panchromatic image (black and white image) and a lower spatial resolution multi-spectral image (color image), a relationship can be established between the panchromatic and multispectral bands if there is enough information about how each pixel breaks down from low resolution to higher resolution. An image can be resampled to provide associated images having lower resolutions. Using pixel values from these successive resolutions, a relationship, such as linear relationship, can be established between two images of the same area, i.e. the same spatial resolution. After establishing the linear relationship, pixel values of the multispectral image can be predicted at the highest spatial resolution of the panchromatic image.

An example of utilization of some embodiments of the present invention, in Landsat 7 data, four pixels of a panchromatic image correspond to a single pixel of a multispectral image. For the panchromatic image, inside the 4×4 pixel window, ratios of each pixel's digital number (DN) value to the super pixel (which is 30 by 30 meters) DN value are the spatial details that the multispectral pixel do not have.

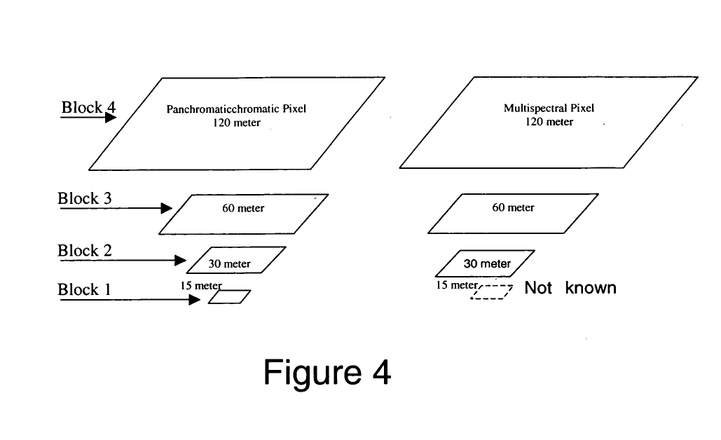

Some embodiments of the present invention will now be described with reference to FIG. 4, which illustrates two images at differing resolutions that are combined through multiresolution fusion. As illustrated in FIG. 4, to measure the digital number (DN) value corresponding to an area, each sensor or image (panchromatic and multispectral) is referred to as a different treatment (i). Thus, the vertical series of differing resolution images illustrated in FIG. 4 reflect the different treatments. Each treatment will, typically, give a different DN value and the size of pixels, typically, affects the DN values. Therefore, each level of spatial resolution (pixel size) will be termed a block (i). The DN value of treatments in block I, DNᵢⱼ, written as:
DNᵢⱼ=μ+Bᵢ+Tⱼ+εᵢⱼ˜(0,δ²) Equation (1)
where, i=1 . . . , b blocks, j=1, . . . , t treatments, μ is an average DN value of whole set, Bi is the ith block effect which is the difference between average value for the ith block across all treatments and the overall average value (uᵢ−u) and Tⱼ=μj−μ, the j^{th} treatment effect. Often, Bᵢ˜(0, δ²)iid and is independent of the error value εᵢⱼ. As further illustrated in FIG. 4, the value for the 15 meter spatial resolution of the multispectral image is unknown, thus, at this point, there is missing data in the model. The missing data can be handled in randomized complete block designs provided that the model does not include block-treatment interaction and there are no cells that are completely missing.

In the present example, the first principal component 1 (PC 1) image of a panchromatic and each multispectral band is added to the design as a third treatment image (not illustrated in FIG. 4). Because the first principal component (PC 1) image of, for example, the multispectral image band1 and a panchromatic image, typically have the best characteristics of both the panchromatic and band1 of the multispectral image, using the PC 1 may be reasonable as a third variable to estimate the unknown 15-meter band1 pixels of the multispectral image. Multispectral bands were pixel replicated to have the same number of pixels that the panchromatic image has for the given area. In certain embodiments of the present invention, the spatial details of the panchromatic image are utilized, rather than the actual DN values. Since the ratios of DN values in high resolution pixels to the DN value of low resolution pixel corresponding to a given area are the spatial details, working with ratios may decrease the amount of distortion of the spectral characteristics of the original image to be enhanced.

The data sets corresponding to the four levels of resolution are blocked into three groups. In the first block of Table 1, a ratio of a 15-meter DN value to a 30-meter DN value is calculated for the each input image. The Ratio of 30-meter to a 60-meter DN value is in the second block of Table 1 and the ratio of 60-meter to a 120-meter DN value is in the third block of Table 1. Table 1 illustrates such a blocking of the data sets.

TABLE 1

| | | | Treatment 3 |
|---|---|---|---|
| | Treatment 1 | | PC 1 of |
| | Multispectral | Treatment 2 | panchromatic & |
| | Band 1 | Panchromatic | band1 |
| Block | Y₁₁ is the ratio of | Y₂₁ is the ratio of | Y₃₁ is the ratio of |
| 1 | 15 m pixel value | 15 m pixel value | 15 m pixel value |
| | to 30 m pixel value | to 30 m pixel value | to 30 m pixel value |
| | of band1 | of panchromatic | |
| | (missing, to be | band | |
| | estimated) | | |
| Block | Y₁₂ is the ratio of | Y₂₂ is the ratio of | Y₃₂ is the ratio of |
| 2 | mean pixel value | mean pixel value | mean pixel value |
| | from 60 m by 60 m | from 60 m by 60 m | from 60 m by 60 m |
| | window to 30 m | window to 30 m | window to 30 m |
| | pixel value of band1 | pixel value of | pixel value |
| | | panchromatic band | |
| Block | Y₁₃ is the ratio of | Y₂₃ is the ratio of | Y₃₃ is the ratio of |
| 3 | mean pixel value | mean pixel value | mean pixel value |
| | from 120 m by 120 | from 120 m by 120 | from 120 m by 120 |
| | m window to 60 m | m window to 60 m | m window to 60 m |
| | pixel value of band1 | pixel value of | pixel value |
| | | panchromatic band | |

Example of the Fusion of Panchromatic and Multispectral Data of FIG. 4

The linear model in matrix notation is:
y=Xβ+ε Equation (2)
Subsequently, the model is:
Y=μ+Bᵢ+τⱼ+εᵢⱼ,εᵢⱼ˜(0,δ²)iid Equation (3)
where; i=1, . . . , b blocks, j=1, . . . , t treatments, Bᵢ is the ith block effect as defined above, τⱼ=μj−μ, the j^{th} treatment, and often, Bᵢ˜(0, δ²) iid and independent of Eᵢⱼ. For t=3 treatments and b=3 blocks, and a missing observation from treatment 1 y₁₁, design matrix can be set up as:

$$\begin{matrix}y = [ \begin{matrix}{y}_{12} \\ {y}_{13} \\ {y}_{21} \\ {y}_{22} \\ {y}_{23} \\ {y}_{31} \\ {y}_{32} \\ {y}_{33}\end{matrix} ] & X = [ \begin{matrix}1 & 1 & 0 & 0 & 1 \\ 1 & 1 & 0 & - 1 & - 1 \\ 1 & 0 & 1 & 1 & 0 \\ 1 & 0 & 1 & 0 & 1 \\ 1 & 0 & 1 & - 1 & - 1 \\ 1 & - 1 & - 1 & 1 & 0 \\ 1 & - 1 & - 1 & 0 & 1 \\ 1 & - 1 & - 1 & - 1 & - 1\end{matrix} ] & β = [ \begin{matrix}μ \\ {B}_{1} \\ {B}_{2} \\ {τ}_{1} \\ {τ}_{2}\end{matrix} ]\end{matrix} \qquad Equation ( 4 )$$

Then the least squares are:
b=(X′X)⁻¹X′y Equation (5)
where X′os the transpose of matrix X and X⁻¹ is the inverse matrix. Substituting the matices of Equation 4, results in the following:

$$[ \begin{matrix}μ \\ {B}_{1} \\ {B}_{2} \\ {τ}_{1} \\ {τ}_{2}\end{matrix} ] = 1 / 12 [ \begin{matrix}2 & 2 & 2 & 1 & 1 & 2 & 1 & 1 \\ 4 & 4 & 0 & - 2 & - 2 & 0 & - 2 & - 2 \\ - 2 & - 2 & 2 & 3 & 3 & - 2 & - 1 & - 1 \\ 0 & 0 & 4 & - 2 & - 2 & 4 & - 2 & - 2 \\ 2 & - 2 & - 2 & 3 & - 1 & - 2 & 3 & - 1\end{matrix} ] [ \begin{matrix}{y}_{12} \\ {y}_{13} \\ {y}_{21} \\ {y}_{22} \\ {y}_{23} \\ {y}_{31} \\ {y}_{32} \\ {y}_{33}\end{matrix} ] \qquad Equation ( 6 )$$

The treatment 1 effect is estimated from blocks 2 and 3 only because block 1 contains the missing data, resulting in the following:

$${τ}_{1} = \frac{1}{2} ( {Y}_{12} + {Y}_{31} ) - \frac{1}{2} ( {\overline{Y}}_{2} + {\overline{Y}}_{3} ) \qquad Equation ( 7 )$$

The missing observation can be estimated using the formula:

$$\begin{matrix}{Y}_{11} = μ + {B}_{1} + {τ}_{1} & Equation ( 8 ) \\ = \frac{1}{2} ( {Y}_{12} + {Y}_{13} + {Y}_{21} + {Y}_{31} ) - \frac{1}{4} ( {Y}_{12} + {Y}_{13} + {Y}_{21} + {Y}_{31} ) & \end{matrix}$$

Since Y₁₁ is the ratio of a 15-meter DN value to a 30-meter DN value of the multispectral pixel, the estimated pixel value of the multispectral band at the 15-meter resolution will be:
DN_{band1-15 m}=DN_{band1-30 m}/Y₁₁ Equation (9)
The same steps may be repeated for all bands. Finally, all the estimated 15-meter images, i.e. bands 1 through 7 in the example, may be stacked together using conventional techniques to obtain a fused (output) multispectral image.

It will be understood that although embodiments of the present invention are discussed herein as having seven bands, embodiments of the present invention are not limited to this configuration. Embodiments of the present invention may have any number of feasible bands without departing from the scope of the present invention.

Furthermore, while embodiments of the present invention have been illustrated using three treatments, in particular embodiments of the present invention two or more than three treatments may be used without departing from the scope of the present invention. Furthermore, while a particular example of three blocks from four different spatial resolution levels are illustrated, other numbers of spatial resolution levels and blocks may also be used. Accordingly, embodiments of the present invention should not be construed as limited to the particular examples provided herein.

The flowcharts and block diagrams of FIGS. 1 through 4 illustrate the architecture, functionality, and operation of possible implementations of systems, methods and computer program products according to various embodiments of the present invention. In this regard, each block in the flow charts or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be understood that each block of the block diagrams and/or flowchart illustrations, and combinations of blocks in the block diagrams and/or flowchart illustrations, can be implemented by special purpose hardware-based systems which perform the specified functions or acts, or combinations of special purpose hardware and computer instructions.

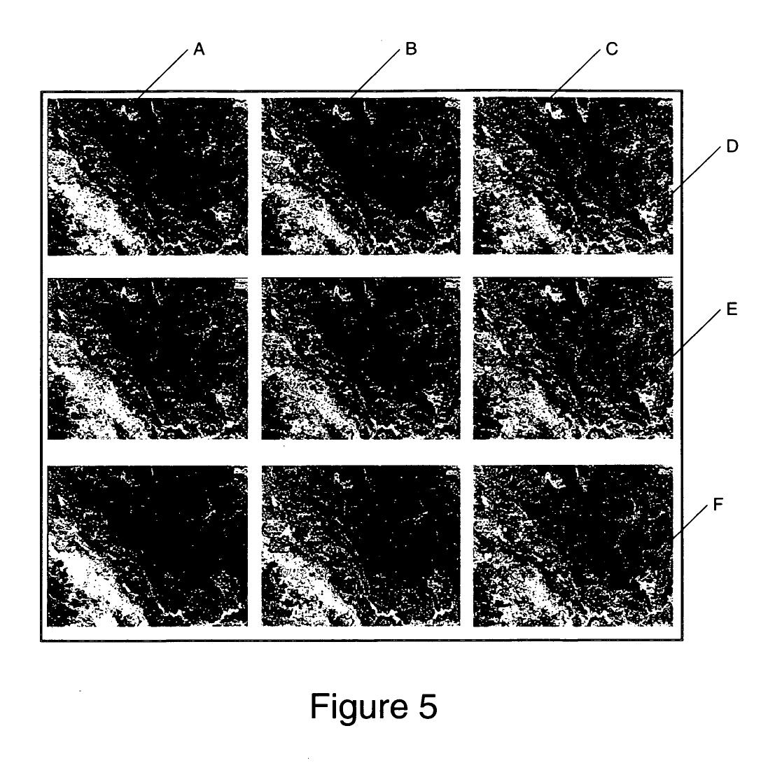

Actual implementation examples of some embodiments of the present invention will now be discussed with respect to FIGS. 5 through 8. These examples are provided to illustrate particular embodiments of the present invention and, thus, embodiments of the present invention are not limited to the embodiments set out in these examples. The source data for the following examples are a sample data set of the San Francisco Bay. This study area was chosen because of its richly varied combination of natural features and urban development. Heterogeneous areas are typically more challenging than homogenous areas when fusing high spatial resolution data with high spectral but low spatial resolution multispectral data. Error rates for producing fused images over heterogeneous areas may be higher than over the homogenous areas. Thus, the results of different fusion methods may be more comparable and more dramatic.

To assess the quality of the proposed method, the disclosure of Fusion of Satellite Images of Different Spatial Resolutions: Assessing the Quality of Resulting Images by Wald et al. (1997) has been used. This paper establishes a framework for quality assessment of fused images. In particular, fused images were compared to original images using visual means. Then, fused images were degraded to original resolutions and compared to original images. Finally, original images were degraded to lower resolutions and then estimated from these degraded images to compare with original images.

Referring now to FIG. 5, a comparison of images fused with different techniques will be discussed. The first column images A are true color, the second column images B are false color composite, and last column images C are mapped as band 7 red, band 5 green, and band 4 blue. The first row of images D are fused images of a study area fused using some embodiments of the present invention. The Second row of images E are original Landsat 7 images and the last row images F are synthetic images fused by the PCA method. As illustrated in FIG. 5, visual comparison of the methods revealed that the PCA method changed the color composition of the original image, while methods according to embodiments of the present invention preserved the color balance. Color balance is the first indication of how well the fusion technique processed. Change of color balance in comparison to the original image is an indication of the change of the radiometric characteristics of the image.

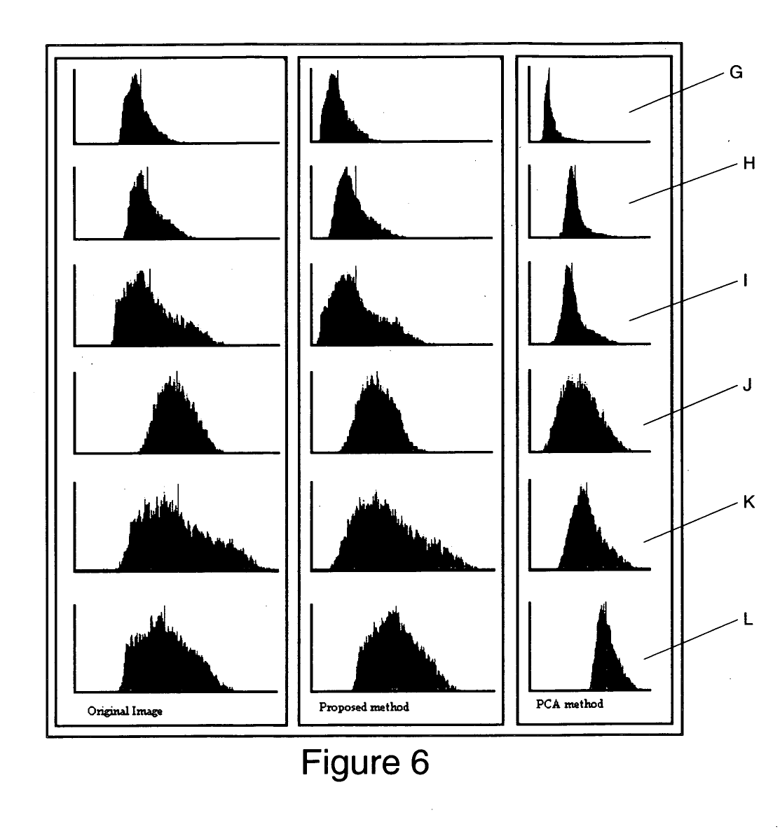

Referring now to FIG. 6, histograms of the original image, images resulting from methods according to embodiments of the present invention (proposed method), and the PCA method images will be discussed. The first through seventh rows correspond to bands 1 G through 7 L. The fused images were degraded to their original resolutions of 30 meters for comparison purposes. Ideally, when a fused image is degraded to original resolution, the resulting image should be as close as possible to the original image as discussed in Wald et al. Checking histograms of each synthesized image after degradation and comparing them with the original image's histograms gives the first glimpse of testing this property. Histograms of the image using embodiments of the present invention were the closest among all methods as illustrated in FIG. 6. Fused images produced according to some embodiments of the present invention provided the histograms that most closely resembled the original ones.

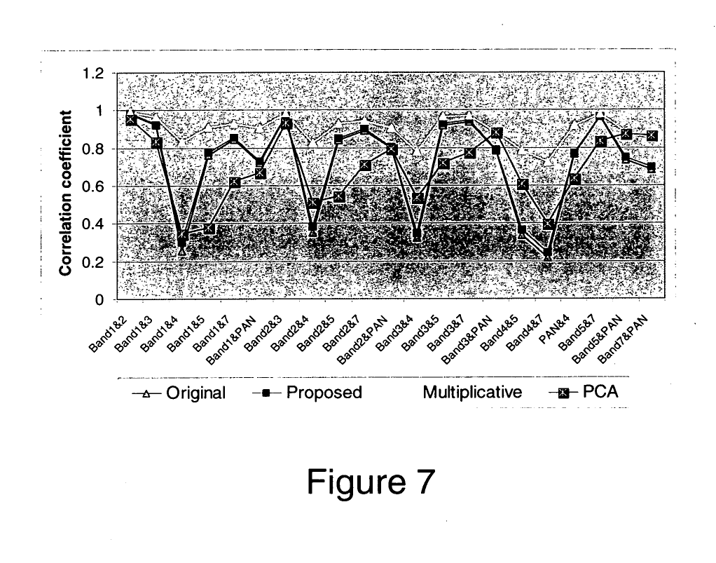

Referring now to FIG. 7, a graph of inter-band correlations for the original and fused images will be discussed. Correlation between bands and panchromatic to each band is another property to preserve when fusing images. The use of Intensity-Hue Saturation Transformations for Merging SPOT Panchromatic and Multispectral Image data by Carper et al. (1990) discusses using correlation to quantify the spectral changes resulting from data merging. This property should be identical to the original image for the fused images when they are degraded to original resolutions. As illustrated in FIG. 7, use of some embodiments of the present invention (marked as “proposed” in FIG. 7) preserved this property. Although PCA performed better than the Multiplicative method, they both violated this property. The Multiplicative method expectedly increased the correlations between bands.

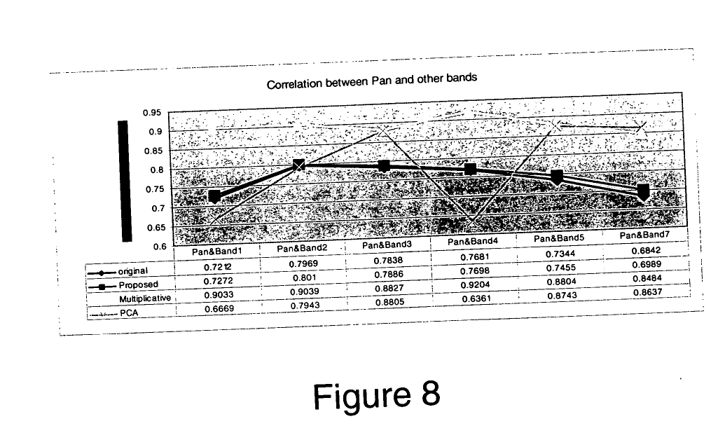

Referring now to FIG. 8, a graph of correlations between panchromatic and other bands for original and fused images will be discussed. The Fused images were degraded to 30 meter for comparison purposes. Analysis of correlation between panchromatic and other bands showed that the Multiplicative method increased the correlations to panchromatic imagery in every band, while methods according to some embodiments of the present invention (proposed) performed well by preserving this property. As expected, the highest correlation between the panchromatic and the original Landsat multispectral bands were in bands 2, 3, and 4. Because the panchromatic band spectrally overlaps the bands 2, 3, and 4, this was expected. For the PCA method, the highest correlations for panchromatic and other bands were in bands 5 and 7.

The statistics on the differences between the original and fused images for PCA and methods according to some embodiments of the present invention are summarized in Table 2. The multiplicative method was not included in this table. Bias, and its relative value to original image mean, is the differences of the means between original and the estimated images as discussed in Wald et al. As seen from Table 2, the bias rate for some embodiments of the present invention (proposed method) for each band was ranging from 0.49 to 0.53. The second variable is the difference in variances and its relative value to original variance. The PCA method introduced too much structure from the panchromatic band, which was also the conclusion of different authors include Wald, et al. The third variable is the correlation coefficient between the original and fused image. It shows the similarity in small size structures between the original and estimated images with an ideal value of 1. Comparing this variable again illustrated improvements of some embodiments of the present invention when compared with the PCA method. The last variable is the standard deviation of the difference image and its relative value to the mean of the original image. This variable globally indicates the error at any pixel.

TABLE 2

| | Bands | 1 | 2 | 3 | 4 | 5 | 7 |
|---|---|---|---|---|---|---|---|
| Bias | PCA | 10.0 | 13.1 | 25 | 6.95 | 31.9 | 24.1 |
| | Proposed | 0.51 | 0.49 | 0.49 | 0.46 | 0.52 | 0.53 |
| Bias relative | PCA | 12.4 | 19.8 | 33.3 | 6.21 | 28.1 | 33.6 |
| to the mean (%) | Proposed | 0.63 | 0.73 | 0.66 | 0.41 | 0.45 | 0.74 |
| Differences | PCA | 81 | 136 | 553 | 28.9 | 972 | 583 |
| in variances | Proposed | 6.73 | 15.9 | 62.9 | 25 | 138 | 83.9 |
| Relative to | PCA | 56.3 | 59.8 | 70.6 | 7 | 75.9 | 80 |
| the actual | Proposed | 4.6 | 7 | 8 | 6 | 10.8 | 11.6 |
| variance (%) | | | | | | | |
| Correlation | PCA | 0.79 | 0.77 | 0.77 | 0.94 | 0.79 | 0.83 |
| coefficient | Proposed | 0.96 | 0.97 | 0.98 | 0.97 | 0.97 | 0.97 |
| between original | | | | | | | |
| & estimate | | | | | | | |
| Standard devia- | PCA | 7.29 | 9.64 | 18.7 | 5.78 | 24.2 | 18.1 |
| tion of the | Proposed | 3.85 | 3.89 | 5.78 | 5.14 | 8.43 | 6.23 |
| differences | | | | | | | |
| Relative to | PCA | 9 | 14.5 | 24.9 | 5.17 | 21.4 | 25.2 |
| the mean (%) | Proposed | 4.76 | 5.86 | 7.7 | 4.59 | 7.44 | 8.67 |

### Statistics on the Differences Between Original and Fused Images

From Table 2, root-mean-square (RMS) error for any given band can be calculated from the formula given in Fusion of High Spatial and Spectral Resolution Images: The ARSIS Concept and Its Implementation by Ranchin (2000). Using the formula:
RMS(Bandᵢ)²=bias(Bandᵢ)²+std_deviation(Bandᵢ)² Equation (10)
total errors for PCA and proposed method were found as 108.87 and 33.45, respectively. The relative average spectral errors (RASE) for PCA and methods according to embodiments of the present invention were calculated from the formula:

$$RASE = \frac{100}{M} \sqrt{\frac{1}{N} {\sum }_{i = 1}^{N} {RMS ( {Band}_{i} )}^{2}} \qquad Equation ( 11 )$$

where M is the mean DN value of the N original bands. Mean DN value for 6 Landsat 7 ETM bands was 86.4919. The RASE of 29.34 and 6.69 were calculated for the PCA and methods according to embodiments of the present invention, respectively. Degradation or resampling has an influence on the final result. For example, when a cubic convolution method was used instead of degradation to resample fused images to the original resolution, the RASE values were improved for both PCA and embodiments of the present invention. The RASE values were 28.79 and 5.51 for PCA and methods according to embodiments of the present invention, respectively.

As briefly discussed above, some embodiments of the present invention may provide improved results over the Multiplicative and/or PCA methods for preserving original image characteristics when fusing images with different spatial resolutions. Because the exemplary embodiments of the present invention may be dependent on the information of how low-resolution pixels break down to high-resolution pixels, the final results may be affected by the resampling method. Although a simple degradation process is used in this analysis, using other, more accurate, resampling techniques may improve the performance of the technique. Thus, any resampling method known to those having skill in the art may be used without departing from the scope of the present invention.

In the drawings and specification, there have been disclosed typical illustrative embodiments of the invention and, although specific terms are employed, they are used in a generic and descriptive sense only and not for purposes of limitation, the scope of the invention being set forth in the following claims.

1. A method of fusing images having different spatial resolutions, comprising:
obtaining data for at least two images having different spatial resolutions;
determining relationships between the at least two images at different spatial resolutions;
determining a relationship between a first of the at least two images at a first spatial resolution and the first of the at least two images at a second spatial resolution, higher than the first spatial resolution, based on the determined relationships between the at least two images at the different spatial resolutions; and
determining pixel values of the first of the at least two images at the second spatial resolution based on pixel values of the first of the at least two images at the first spatial resolution and the determined relationship between the first of the at least two images at the first spatial resolution and the first of the at least two images at the second spatial resolution.

2. The method of claim 1, wherein obtaining data for at least two images comprises obtaining data for a multispectral image and a panchromatic image.

3. The method of claim 1, wherein obtaining data for at least two images comprises obtaining data for an image having a high spatial resolution and a low spectral resolution and for an image having a low spatial resolution and a high spectral resolution.

4. The method of claim 2, wherein obtaining data further comprises:
resampling the multispectral image to obtain lower resolution images associated with the multispectral image; and
resampling the panchromatic image to obtain lower resolution images associated with the panchromatic image.

5. The method of claim 1, wherein the determined relationships between the at least two images at different spatial resolutions comprise linear relationships.

6. The method of claim 1, wherein determining pixel values comprises determining pixel values using a first principal component of the first of the at least two images at the first spatial resolution.

7. The method of claim 1, wherein determining relationships between the at least two images at different spatial resolutions comprises determining relationships between the at least two images having different areas, wherein the areas are associated with corresponding digital value numbers.

8. The method of claim 7, wherein the digital value numbers comprises a fifteen meter digital value number, a thirty meter digital value number, a sixty meter digital value number and/or a one hundred and twenty meter digital value number.

9. A system for fusing images having different spatial resolutions, comprising a data fusion circuit configured to:
obtain data for at least two images having different spatial resolutions;
determine relationships between the at least two images at different spatial resolutions;
determine a relationship between a first of the at least two images at a first spatial resolution and the first of the at least two images at a second spatial resolution, higher than the first spatial resolution, based on the determined relationships between the at least two images at the different spatial resolutions; and
determine pixel values of the first of the at least two images at the second spatial resolution based on pixel values of the first of the at least two images at the first spatial resolution and the determined relationship between the first of the at least two images at the first spatial resolution and the first of the at least two images at the second spatial resolution.

10. The system of claim 9, wherein the data fusion circuit is further configured to obtain data for a multispectral image and a panchromatic image.

11. The system of claim 9, wherein the data fusion circuit is further configured to obtain data for an image having a high spatial resolution and a low spectral resolution and for an image having a low spatial resolution and a high spectral resolution.

12. The system of claim 9, wherein the data fusion circuit is further configured to:
resample the multispectral image to obtain lower resolution images associated with the multispectral image; and
resample the panchromatic image to obtain lower resolution images associated with the panchromatic image.

13. The system of claim 9, wherein the determined relationships between the at least two images at different spatial resolutions comprise linear relationships.

14. The system of claim 9, wherein the data fusion circuit is further configured to determine pixel values using a first principal component of the first of the at least two images at the first spatial resolution.

15. The system of claim 9, wherein the data fusion circuit is further configured to determine relationships between the at least two images having different areas, wherein the areas are associated with corresponding digital value numbers.

16. The system of claim 15, wherein the digital value numbers comprises a fifteen meter digital value number, a thirty meter digital value number, a sixty meter digital value number and/or a one hundred and twenty meter digital value number.

17. A system for fusing images having different spatial resolutions, comprising:
means for obtaining data for at least two images having different spatial resolutions;
means for determining relationships between the at least two images at different spatial resolutions;
means for determining a relationship between a first of the at least two images at a first spatial resolution and the first of the at least two images at a second spatial resolution, higher than the first spatial resolution, based on the determined relationships between the at least two images at the different spatial resolutions; and
means for determining pixel values of the first of the at least two images at the second spatial resolution based on pixel values of the first of the at least two images at the first spatial resolution and the determined relationship between the first of the at least two images at the first spatial resolution and the first of the at least two images at the second spatial resolution.

18. A computer program product for fusing images having different spatial resolutions, the computer program product comprising:
computer readable storage medium having computer readable program code embodied in said medium, the computer readable program code comprising:
computer readable program code configured to obtain data for at least two images having different spatial resolutions;
computer readable program code configured to determine relationships between the at least two images at different spatial resolutions;
computer readable program code configured to determine a relationship between a first of the at least two images at a first spatial resolution and the first of the at least two images at a second spatial resolution, higher than the first spatial resolution, based on the determined relationships between the at least two images at the different spatial resolutions; and
computer readable program code configured to determine pixel values of the first of the at least two images at the second spatial resolution based on pixel values of the first of the at least two images at the first spatial resolution and the determined relationship between the first of the at least two images at the first spatial resolution and the first of the at least two images at the second spatial resolution.

19. The computer program product of claim 18, wherein the computer readable program code configured to obtain data for at least two images comprises computer readable program code configured to obtain data for a multispectral image and a panchromatic image.

20. The computer program product of claim 18, wherein the computer readable program code configured to obtain data for at least two images comprises computer readable program code configured to obtain data for an image having a high spatial resolution and a low spectral resolution and for an image having a low spatial resolution and a high spectral resolution.

21. The computer program product of claim 18, wherein the computer readable program code configured to obtain data further comprises:
computer readable program code configured to resample the multispectral image to obtain lower resolution images associated with the multispectral image; and
computer readable program code configured to resample the panchromatic image to obtain lower resolution images associated with the panchromatic image.

22. The computer program product of claim 18, wherein the determined relationships between the at least two images at different spatial resolutions comprise linear relationships.

23. The computer program product of claim 18, wherein the computer readable code configured to determining pixel values comprises computer readable code configured to determine pixel values using a first principal component of the first of the at least two images at the first spatial resolution.

24. The computer program product of claim 18, wherein the computer readable program code configured to determine relationships between the at least two images at different spatial resolutions comprises computer readable program code configured to determine relationships between the at least two images having different areas, wherein the areas are associated with corresponding digital value numbers.

25. The computer program product of claim 24, wherein the digital value numbers comprises a fifteen meter digital value number, a thirty meter digital value number, a sixty meter digital value number and/or a one hundred and twenty meter digital value number.
